(19) United States
(12) Patent Application Publication
(10) Pub. No.: US 2026/0251897 A1
(43) Pub. Date: Aug. 27, 2026

(54) LIGHT SOURCE UNIT AND IMAGE DISPLAY DEVICE

(71) Applicant: NICHIA CORPORATION, Anan-shi, Tokushima (JP)

(72) Inventors: Wataru KITAHARA, Kamiina-gun (JP); Takanori ARUGA, Suwa-gun (JP); Hajime AKIMOTO, Anan-shi (JP)

(73) Assignee: NICHIA CORPORATION, Anan-shi, Tokushima (JP)

(21) Appl. No.: 18/870,981

(22) PCT Filed: Mar. 2, 2023
(86) PCT No.: PCT/JP2023/007848

§ 371 Date: Dec. 2, 2024

(30) Foreign Application Priority Data
Jun. 8, 2022 (JP) 2022-092775

(51) Int. Cl. G02B 27/01

(52) U.S. Cl. CPC G02B 27/0101

(57) ABSTRACT

A light source unit includes: a first display device configured to display a first picture; a second display device configured to display a second picture; a first polarizing plate configured to convert light emitted from the first display device into first polarized light having a first polarization direction; a second polarizing plate configured to convert light emitted from the second display device into second polarized light having a second polarization direction; a reflective polarizing plate configured to transmit the first polarized light and reflect the second polarized light; a first reflective member configured to reflect the first polarized light and project a first image corresponding to the first picture; a second reflective member configured to reflect the second polarized light and project a second image corresponding to the second picture; and a second wave plate between the reflective polarizing plate and the second reflective member.

### CROSS-REFERENCE TO RELATED APPLICATIONS

This application is a national stage application of PCT Application No. PCT/JP 2023/007848, filed on Mar. 2, 2023, which claims priority to Japanese Patent Application No. 2022-092775, filed on Jun. 8, 2022.

### BACKGROUND

Embodiments of the present invention relate to a light source unit and a image display device.

Japanese U.S. Pat. No. 6,809,441 B (“Patent Document 1”) discloses a display device that displays two virtual images in a visible manner using two displays. In the display device disclosed in Patent Document 1, because a path of light forming one virtual image and a path of light forming the other virtual image are optically largely different from each other, how the two virtual images are viewed becomes uneven, resulting in a problem that display quality is degraded as a whole.

### SUMMARY

### Technical Problem

An object of an embodiment of the present invention is to provide a light source unit and a image display device that can improve the quality of a virtual image.

### Solution to Problem

A light source unit according to an embodiment of the present invention includes a first display device capable of displaying a first picture, a second display device configured to display a second picture, a first polarizing plate capable of converting light emitted from the first display device into first polarized light having a first polarization direction, a second polarizing plate configured to convert light emitted from the second display device into second polarized light having a second polarization direction different from the first polarization direction, a reflective polarizing plate configured to transmit the first polarized light and reflect the second polarized light, a first reflective member, a first wave plate disposed between the reflective polarizing plate and the first reflective member, a second reflective member, and a second wave plate disposed between the reflective polarizing plate and the second reflective member. The first reflective member that includes a first concave surface, and is configured to reflect, from the first concave surface, the first polarized light transmitted through the reflective polarizing plate toward the reflective polarizing plate and project a first image corresponding to the first picture on a projection part, thereby allowing an image visually recognizable by a viewer to be displayed beyond the projection part when viewed by the viewer. The second reflective member that includes a second concave surface, and is configured to reflect, from the second concave surface, the second polarized light reflected by the reflective polarizing plate toward the reflective polarizing plate and project a second image corresponding to the second picture on the projection part, thereby allowing an image visually recognizable by the viewer to be displayed beyond the projection part when viewed by the viewer. A first optical path length of the light emitted from the first display device from the first display device to the first reflective member is longer than a second optical path length of the light emitted from the second display device from the second display device to the second reflective member, and a curvature of the first concave surface is larger than a curvature of the second concave surface. Alternatively, the first optical path length is shorter than the second optical path length and the curvature of the first concave surface is smaller than the curvature of the second concave surface.

A image display device according to an embodiment of the present invention includes the light source unit, and a reflection unit that is spaced apart from the light source unit and is configured to reflect light emitted from the light source unit. The first image and the second image are formed between the light source unit and the reflection unit.

### Advantageous Effects of Invention

Embodiments of the present invention can implement a light source unit and a image display device that can improve the quality of a virtual image.

### BRIEF DESCRIPTION OF THE DRAWINGS

FIG. 1 is an end view illustrating a image display device according to a first embodiment.

FIG. 2 is an end view illustrating a light source unit according to the first embodiment.

FIG. 3 is an end view illustrating a display device of the image display device according to the first embodiment.

FIG. 4 is a schematic view illustrating scenery viewed from a viewer in a driver's seat.

FIG. 5A is a schematic view illustrating the principle of the light source unit according to the first embodiment.

FIG. 5B is a schematic view illustrating the principle of a light source unit according to a reference example.

FIG. 6A is a graph showing light distribution patterns of light emitted from one light-emitting area in first and eleventh examples, a reference example, and LCD.

FIG. 6B is a graph showing the uniformity of luminance of a third image in the first to twelfth examples and the reference example.

FIG. 7 is an end view illustrating a light source unit according to a second embodiment.

FIG. 8 is a cross-sectional view illustrating an enlarged portion of a first display device in the second embodiment.

FIG. 9 is an end view illustrating a light source unit according to a third embodiment.

FIG. 10 is a perspective view illustrating a wire grid polarizing plate in a fourth embodiment.

### DETAILED DESCRIPTION

### First Embodiment

First, a first embodiment is described.

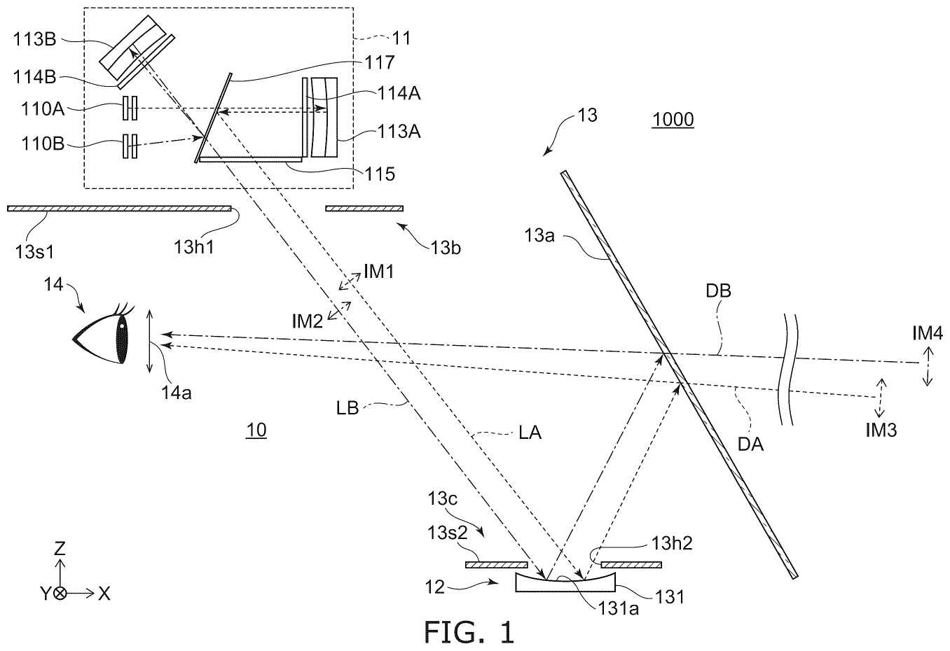

FIG. 1 is an end view illustrating a image display device according to the present embodiment.

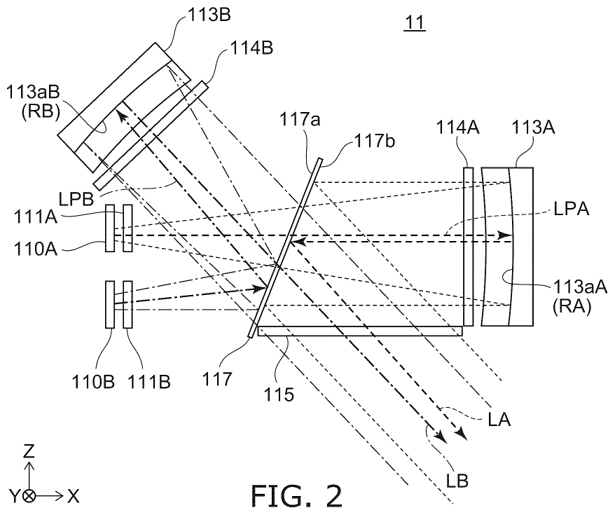

FIG. 2 is an end view illustrating a light source unit according to the present embodiment.

As illustrated in FIGS. 1 and 2, a image display device 10 according to the present embodiment is mounted on, for example, an automobile 1000 and constitutes a head-up display (HUD). The automobile 1000 includes a vehicle 13 and the image display device 10 fixed to the vehicle 13. A viewer 14 is an occupant of the automobile 1000, for example, a driver.

The image display device 10 includes a light source unit 11 and a reflection unit 12. The light source unit 11 includes a first display device 110A, a second display device 110B, a first polarizing plate 111A, a second polarizing plate 111B, a reflective polarizing plate 117, a first reflective member 113A, a second reflective member 113B, a first wave plate 114A, second wave plate 114B, and a third wave plate 115.

The first display device 110A can display a first picture. The second display device 110B can display a second picture. As described below, the first picture and the second picture are pictures that are virtual images viewed, by the viewer 14, beyond a front windshield 13a of the vehicle 13. The first picture and the second picture are, for example, character strings, figures, and/or the like.

The first polarizing plate 111A converts light emitted from the first display device 110A into first polarized light having a first polarization direction. The first polarized light is, for example, P polarized light. The second polarizing plate 111B converts light emitted from the second display device 110B into second polarized light having a second polarization direction. The second polarized light is, for example, S polarized light. The second polarization direction is different from the first polarization direction, and is, for example, orthogonal to the first polarization direction. The reflective polarizing plate 117 transmits the first polarized light (for example, P polarized light) and reflects the second polarized light (for example, S polarized light). The “P polarized light” means light in which the oscillation direction of an electric field is substantially parallel to a YZ plane. The “S polarized light” means light in which the oscillation direction of the electric field is substantially perpendicular to the YZ plane including incident light and reflected light.

The first reflective member 113A has a first concave surface 113aA. The first reflective member 113A reflects, from the first concave surface 113aA, the first polarized light transmitted through the reflective polarizing plate 117 toward the reflective polarizing plate 117, and projects a first image IM1 corresponding to the first picture on a projection part. Thus, an image (third image IM3) that can be visually recognized by the viewer 14 is displayed beyond the projection part when viewed by the viewer 14. In the present embodiment, the projection part is, for example, the front windshield 13a of the vehicle 13. However, the projection part may be a combiner.

The second reflective member 113B has a second concave surface 113aB. The second reflective member 113B reflects, from the second concave surface 113aB, the second polarized light reflected by the reflective polarizing plate 117 toward the reflective polarizing plate 117, and projects a second image IM2 corresponding to the second picture on the projection part. Thus, an image (fourth image IM4) that can be visually recognized by the viewer 14 is displayed beyond the projection part when viewed by the viewer 14.

The first wave plate 114A is disposed between the reflective polarizing plate 117 and the first reflective member 113A. The second wave plate 114B is disposed between the reflective polarizing plate 117 and the second reflective member 113B. The third wave plate 115 transmits the light reflected by the first reflective member 113A and reflected by the reflective polarizing plate 117 and the light reflected by the second reflective member 113B and transmitted through the reflective polarizing plate 117.

The first image IM1 and the second image IM2 are real images and intermediate images. The third image IM3 is a virtual image larger than the first image IM1. The fourth image IM4 is a virtual image larger than the second image IM2. The first picture, the first image IM1, and the third image IM3 are substantially in a similarity relationship. The second picture, the second image IM2, and the fourth image IM4 are substantially in a similarity relationship.

The first wave plate 114A, the second wave plate 114B, and the third wave plate 115 are, for example, ¼ λ plates. However, the first wave plate 114A, the second wave plate 114B, and the third wave plate 115 do not have to be ¼ λ plates. The third wave plate 115 does not have to be provided.

In the example illustrated in FIG. 2, a first optical path length LPA of light emitted from the first display device 110A from the first display device 110A to the first reflective member 113A is longer than a second optical path length LPB of light emitted from the second display device 110B from the second display device 110B to the second reflective member 113B, and a curvature RA of the first concave surface 113aA is larger than a curvature RB of the second concave surface 113aB, that is, LPA>LPB and RA>RB.

In another example, the first optical path length LPA is shorter than the second optical path length LPB, and the curvature RA of the first concave surface 113aA is smaller than the curvature RB of the second concave surface 113aB. That is, LPA<LPB and RA<RB may be satisfied.

The reflection unit 12 is spaced apart from the light source unit 11 and reflects light emitted from the light source unit 11. The first image IM1 and the second image IM2 are formed between the light source unit 11 and the reflection unit 12.

The front windshield 13a reflects, on its inner surface, the light having reached from the reflection unit 12, and causes the light to enter an eye box 14a of the viewer 14. Thus, the viewer 14 can visually recognize the third image IM3 and the fourth image IM4. The “eye box” refers to a range in which a virtual image can be visually recognized in a space in front of the eyes of a viewer.

The positional relationship among the components of the image display device 10 is described below.

Hereinafter, for ease of explanation, an XYZ orthogonal coordinate system is adopted. In the present embodiment, the front-rear direction of the vehicle 13 is referred to as an “X direction”, the left-right direction of the vehicle 13 is referred to as a “Y direction”, and the up-down direction of the vehicle 13 is referred to as a “Z direction”. An XY plane is a horizontal plane of the vehicle 13. In the X direction, the direction (forward) of an arrow is also referred to as a “+X direction”, and the opposite direction (rearward) thereof is also referred to as a “−X direction”. In the Y direction, the direction (leftward) of an arrow is referred to as a “+Y direction”, and the opposite direction (rightward) thereof is referred to as a “−Y direction”. In the Z directions, the direction (upward) of an arrow is referred to as a “+Z direction”, and the opposite direction (downward) thereof is referred to as a “−Z direction”.

As illustrated in FIG. 1, in the present embodiment, the light source unit 11 is provided on a ceiling portion 13b of the vehicle 13. The light source unit 11 is disposed, for example, on an inner side of a wall 13s1 exposed to the interior of the vehicle in the ceiling portion 13b. The wall 13s1 is provided with a through hole 13h1 through which light emitted from the light source unit 11 can pass. The light emitted from the light source unit 11 passes through the through hole 13h1 and is emitted to a space between the viewer 14 and the front windshield 13a. The light source unit 11 may be attached to a ceiling surface of the vehicle 13.

The through hole 13h1 may be provided with a cover that is transparent, translucent, or colored in black or the like and has a small haze value. By providing the cover, adhesion of dust or the like to an optical unit can be suppressed. In addition, visual recognition of the light source unit 11 through the through hole 13h1 can be suppressed, so that designability can be improved. The haze value is preferably 50% or less, more preferably 20% or less. When the cover has such a haze value, the above-described effects can be obtained while suppressing a significant decrease in the luminance of the light emitted from the light source unit 11 and disturbance of a picture.

As illustrated in FIG. 2, in the light source unit 11, the first display device 110A and the second display device 110B are disposed with their picture display surfaces facing in the +X direction. The first display device 110A and the second display device 110B are arranged along the Z direction, and the first display device 110A is disposed on the +Z direction side (upper side) with respect to the second display device 110B. However, no such limitation is intended, and the second display device 110B may be disposed on the +Z direction side (upper side) with respect to the first display device 110A. The first display device 110A and the second display device 110B may be arranged along the Y direction.

The first polarizing plate 111A is disposed on the +X direction side (front side) of the first display device 110A. Thus, light (light forming the first picture) emitted from the first display device 110A is incident on the first polarizing plate 111A. The second polarizing plate 111B is disposed on the +X direction side (front side) of the second display device 110B. Thus, light (light forming the second picture) emitted from the second display device 110B is incident on the second polarizing plate 111B.

The reflective polarizing plate 117 is disposed on the +X direction side of the first polarizing plate 111A and the second polarizing plate 111B. The reflective polarizing plate 117 is inclined with respect to the Z direction so as to be displaced in the +X direction toward the +Z direction. The reflective polarizing plate 117 has a first surface 117a and a second surface 117b opposite to the first surface 117a. The first surface 117a is directed in a direction between the +Z direction and the −X direction and faces the first polarizing plate 111A and the second polarizing plate 111B. The second surface 117b is directed in a direction between the-Z direction and the +X direction.

The first wave plate 114A is disposed on the +X direction side of the reflective polarizing plate 117, and faces the second surface 117b of the reflective polarizing plate 117. The first reflective member 113A is disposed on the +X direction side of the first wave plate 114A, and the first concave surface 113aA of the first reflective member 113A is directed in the −X direction side. Thus, the first concave surface 113aA faces the first wave plate 114A. As a result, the first display device 110A, the first polarizing plate 111A, the reflective polarizing plate 117, the first wave plate 114A, and the first reflective member 113A are arranged on the same straight line in this order along the +X direction.

The second wave plate 114B is disposed in a direction between the −X direction and the +Z direction when viewed from the reflective polarizing plate 117, and faces the first surface 117a of the reflective polarizing plate 117. The second reflective member 113B is disposed on the side of the second wave plate 114B in the direction between the −X direction and the +Z direction, and the second concave surface 113aB of the second reflective member 113B faces the side of the direction between the +X direction and the −Z direction. Thus, the second concave surface 113aB faces the second wave plate 114B. As a result, the second display device 110B, the second polarizing plate 111B, and the reflective polarizing plate 117 are arranged on the same straight line in this order along the +X direction, and the reflective polarizing plate 117, the second wave plate 114B, and the second reflective member 113B are arranged on the same straight line in this order along the direction between the −X direction and the +Z direction.

The third wave plate 115 is disposed in the direction between the +X direction and the −Z direction when viewed from the reflective polarizing plate 117, and faces the second surface 117b of the reflective polarizing plate 117. Light reaching the third wave plate 115 from the reflective polarizing plate 117 and transmitted through the third wave plate 115 is emitted in the direction between the +X direction and the −Z direction.

In this way, the first display device 110A and the first polarizing plate 111A, the second display device 110B and the second polarizing plate 111B, the second wave plate 114B and the second reflective member 113B are disposed on the first surface 117a side of the reflective polarizing plate 117. However, the first display device 110A and the first polarizing plate 111A are disposed at positions where the first display device 110A and the first polarizing plate 111A do not obstruct an optical path between the second display device 110B and the reflective polarizing plate 117 and an optical path between the reflective polarizing plate 117 and the second reflective member 113B. The second display device 110B and the second polarizing plate 111B are disposed at positions where the second display device 110B and the second polarizing plate 111B do not obstruct an optical path between the first display device 110A and the reflective polarizing plate 117 and an optical path between the reflective polarizing plate 117 and the second reflective member 113B. The second wave plate 114B and the second reflective member 113B are disposed at positions where the second wave plate 114B and the second reflective member 113B do not obstruct an optical path between the first display device 110A and the reflective polarizing plate 117 and an optical path between the second display device 110B and the reflective polarizing plate 117.

The first wave plate 114A, the first reflective member 113A, and the third wave plate 115 are disposed on the second surface 117b side of the reflective polarizing plate 117. However, the first wave plate 114A and the first reflective member 113A are disposed at positions where the first wave plate 114A and the first reflective member 113A do not obstruct an optical path between the reflective polarizing plate 117 and the third wave plate 115. The third wave plate 115 is disposed at a position where the third wave plate 115 does not obstruct an optical path between the reflective polarizing plate 117 and the first reflective member 113A.

As illustrated in FIG. 1, in the present embodiment, the reflection unit 12 is provided in a dashboard portion 13c of the vehicle 13. The reflection unit 12 is disposed, for example, on an inner side of a wall 13s2 exposed to the interior of the vehicle in the dashboard portion 13c. The wall 13s2 is provided with a through hole 13h2 through which light emitted from the light source unit 11 can pass. Like the through hole 13h1, the through hole 13h2 may be provided with cover that is transparent, translucent, or colored in black or the like and has a small haze value. In the present embodiment, the reflection unit 12 includes a mirror 131 having a concave mirror surface 131a. The mirror 131 faces the front windshield 13a. The mirror 131 may include a body member formed of glass, a resin material, or the like, and a reflective film such as a metal film or a dielectric multilayer film that is provided on the surface of the body member and forms the mirror surface 131a. The mirror 131 may be entirely formed of a metal material. In an example, the mirror surface 131a is a biconic surface. However, the mirror surface may be a part of a spherical surface or may be a free-form surface.

The configurations of the first display device 110A and the second display device 110B in the light source unit 11 are described in detail below.

The first display device 110A is a first LED display including a plurality of LED elements. The second display device 110B is a second LED display including a plurality of LED elements. Hereinafter, the first display device 110A and the second display device 110B are also collectively referred to as “display device 110”. That is, the following description of the “display device 110” applies to both the first display device 110A and the second display device 110B. However, one of the first display device 110A and the second display device 110B may have a configuration different from that described below.

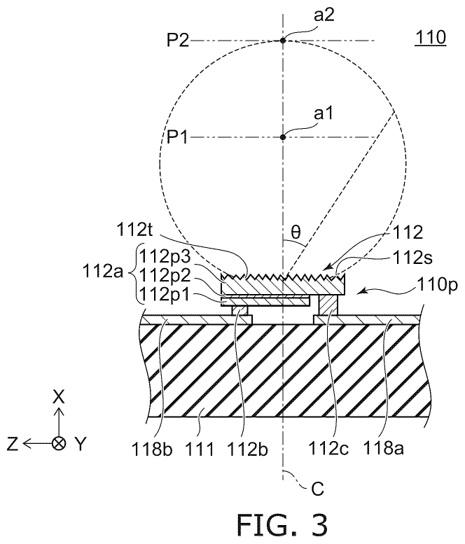

FIG. 3 is an end view illustrating the display device of the image display device according to the present embodiment.

In the display device 110, a plurality of LED elements 112 as illustrated in FIG. 3 are arranged in a matrix. One or more LED elements 112 correspond to each pixel of the display device 110.

In the display device 110, each LED element 112 is mounted face-down on a substrate 111. However, each LED element may be mounted face-up on the substrate. Each LED element 112 includes a semiconductor layered body 112a, an anode electrode 112b, and a cathode electrode 112c.

The semiconductor layered body 112a includes a p-type semiconductor layer 112p1, an active layer 112p2 disposed on the p-type semiconductor layer 112p1, and an n-type semiconductor layer 112p3 disposed on the active layer 112p2. For the semiconductor layered body 112a, for example, a gallium nitride-based compound semiconductor expressed as In_{X}Al_{Y}Ga_{1-X-Y}N (0≤X, 0≤Y, X+Y<1) is used. Light emitted by the LED element 112 is visible light in the present embodiment.

The anode electrode 112b is electrically connected to the p-type semiconductor layer 112p1. The anode electrode 112b is electrically connected to a wiring part 118b. The cathode electrode 112c is electrically connected to the n-type semiconductor layer 112p3. The cathode electrode 112c is electrically connected to another wiring part 118a. For each of the electrodes 112b and 112c, for example, a metal material can be used.

In the present embodiment, a plurality of recessed portions 112t are provided on a light exit surface 112s of each of the LED elements 112. In the present specification, the “light exit surface of the LED element” means a surface from which light to be incident on an imaging optical system 120 is mainly emitted among the surfaces of the LED element. In the present embodiment, the surface of the n-type semiconductor layer 112p3 located on a side opposite to a surface facing the active layer 112p2 corresponds to the light exit surface 112s.

Hereinafter, an optical axis of light emitted from each pixel 110p is simply referred to as “optical axis C”. The optical axis C is, for example, a straight line connecting a point a1 and a point a2, the point a1 having a maximum luminance in a range irradiated with light from one pixel 110p on a first plane P1 parallel to the YZ plane on which a plurality of pixels 110p are arranged and located on the light exit side of the display device 110, the point a2 having a maximum luminance in a range irradiated with the light from the pixel 110p on a second plane P2 parallel to the YZ plane and separated from the first plane P1. When there are a plurality of points at which the luminance is maximum, for example, the center point of these points may be set as the point at which the luminance is maximum. From the viewpoint of productivity, the optical axis C is desirably parallel to an X-axis.

Because the plurality of recessed portions 112t are provided in the light exit surface 112s of each LED element 112, light emitted from the LED element 112, that is, light emitted from each pixel 110p has a substantially Lambertian light distribution as indicated by a broken line in FIG. 3. Here, “the light emitted from each pixel has a substantially Lambertian light distribution” means that the light has a light distribution pattern in which the luminous intensity of each pixel in a direction at an angle e with respect to the optical axis C can be approximated by cosne times the luminous intensity on the optical axis C, where n is a value greater than 0. Here, n is preferably 11 or less, more preferably 1. Although there are many planes including the optical axis C of light emitted from one pixel 110p, the light distribution pattern of the light emitted from the pixel 110p in each plane is a substantially Lambertian light distribution and the numerical value of n is also approximately the same.

The values of n for the first display device 110A and the second display device 110B are preferably equal to each other, but do not have to be equal to each other. That is, light emitted from the first display device 110A has a light distribution pattern in which the luminous intensity of the light emitted from the first display device 110A in the direction at the angle 0 with respect to the optical axis C is approximated by cosne times the luminous intensity on the optical axis C. In addition, light emitted from the second display device 110B has a light distribution pattern in which the luminous intensity of the light emitted from the second display device 110B in the direction at the angle e with respect to the optical axis C is approximated by cos 20 times the luminous intensity on the optical axis C. Each of n1 and n2 is a value greater than 0, and preferably 11 or less, more preferably 1. n1 and n2 are preferably equal to each other.

The first reflective member 113A has a substantially telecentric property on the first image IM1 side. The second reflective member 113B has a substantially telecentric property on the second image IM2 side. Here, “the first reflective member 113A has a substantially telecentric property on the first image IM1 side” means that a plurality of principal rays LA emitted from mutually different positions in the first display device 110A to reach the first image IM1 via the first reflective member 113A are substantially parallel to each other before and after the first image IM1. The different positions are, for example, different pixels 110p of the first display device 110A. “The plurality rays LA are substantially parallel to each other” means that the principal rays LA are substantially parallel to each other within a practical range in which a tolerance due to manufacturing accuracy, assembly accuracy, or the like of the components of the light source unit 11 is allowed. When “the plurality of principal rays L are substantially parallel to each other”, for example, an angle between the principal rays LA is 10° or less. The same applies to “the second reflective member 113B has a substantially telecentric property on the second image IM2 side”. Note that one of the first reflective member 113A and the second reflective member 113B does not have to have a substantially telecentric property.

When the first reflective member 113A has a substantially telecentric property on the first image IM1 side, the plurality of principal rays LA intersect with each other before entering the first reflective member 113A. FIG. 2 and the like do not illustrate this intersection to simplify the drawings. Hereinafter, a point at which the plurality of principal rays LA intersect with each other is referred to as a “focal point F”. Therefore, whether the first reflective member 113A has a substantially telecentric property on the first image IM1 side can be confirmed by, for example, the following method using the reversibility of light-path. First, a light source that can emit parallel light, such as a laser light source, is disposed near the position where the first image IM1 is formed. The reflective polarizing plate 117 is irradiated with light emitted from the light source. The light emitted from the light source to pass through the reflective polarizing plate 117 is incident on the first reflective member 113A. Subsequently, when a point where light emitted from the first reflective member 113A is condensed, that is, the focal point F is present before the light reaches the display device 110A, it can be determined that the first reflective member 113A has a substantially telecentric property on the first image IM1 side. The same applies to a case in which the second reflective member 113B has a substantially telecentric property on the second image IM2 side.

The operation of the image display device 10 according to the present embodiment is described below.

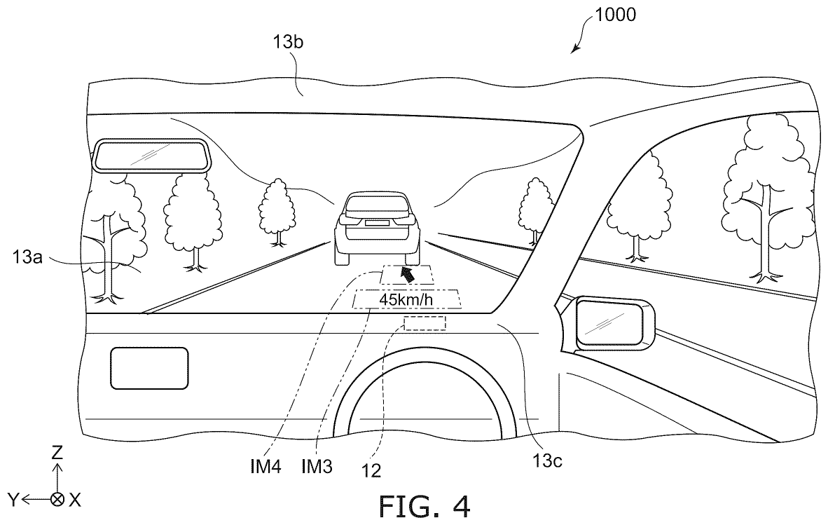

FIG. 4 is a schematic view illustrating scenery viewed from a viewer in a driver's seat.

As illustrated in FIG. 2, the first display device 110A displays the first picture. Light emitted from the first display device 110A becomes first polarized light (for example, P-polarized light) having a first polarization direction by passing through the first polarizing plate 111A. When the first polarized light reaches the first surface 117a of the reflective polarizing plate 117, the reflective polarizing plate 117 transmits the first polarized light.

Subsequently, the first polarized light transmitted through the reflective polarizing plate 117 becomes circularly polarized light by passing through the first wave plate 114A, is reflected and condensed by the first concave surface 113aA the first reflective member 113A, becomes second polarized light (for example, S-polarized light) by passing through the first wave plate 114A again, and returns to the second surface 117b of the reflective polarizing plate 117. The second polarized light is reflected by the second surface 117b of the reflective polarizing plate 117, becomes circularly polarized light LA by passing through the third wave plate 115, and is emitted obliquely downward from the light source unit 11, that is, in the direction between the +X direction and the −Z direction.

On the other hand, the second display device 110B displays the second picture. The light emitted from the second display device 110B becomes second polarized light (for example, S-polarized light) having a second polarization direction by passing through the second polarizing plate 111B. When the second polarized light reaches the first surface 117a of the reflective polarizing plate 117, the first surface 117a of the reflective polarizing plate 117 reflects the second polarized light.

Subsequently, the second polarized light reflected by the reflective polarizing plate 117 becomes circularly polarized light by passing through the second wave plate 114B, is reflected and condensed by the second concave surface 113aB of the second reflective member 113B, becomes first polarized light (for example, P-polarized light) by passing through the second wave plate 114B again, and returns to the first surface 117a of the reflective polarizing plate 117. When the first polarized light reaches the first surface 117a of the reflective polarizing plate 117, the first polarized light is transmitted through the reflective polarizing plate 117 and reaches the third wave plate 115. The first polarized light becomes circularly polarized light LB by passing through the third wave plate 115, and is emitted obliquely downward from the light source unit 11, that is, in the direction between the +X direction and the −Z direction.

In this way, as illustrated in FIG. 1, the light LA having information of the first picture and the light LB having information of the second picture are emitted from the light source unit 11. The light LA and the light LB form the first image IM1 and the second image IM2, respectively, between the light source unit 11 and the reflection unit 12.

After forming the first image IM1 and the second image IM2, the light LA and the light LB reach the reflection unit 12. The light LA and the light LB pass through the through hole 13h2 provided in the wall 13s2 of the dashboard portion 13c, are reflected and condensed by the mirror surface 131a of the mirror 131, pass through the through hole 13h2 again, and travel toward the front windshield 13a. Subsequently, the light LA and the light LB are reflected in the-X direction (rearward) on the inner surface of the front windshield 13a and enter the eye box 14a of the viewer 14.

Thus, as illustrated in FIG. 4, the viewer 14 recognizes the third image IM3 by the light LA entering the eye box 14a, and recognizes the fourth image IM4 by the light LB entering the eye box 14a. The third image IM3 is a virtual image based on the first picture, and the fourth image IM4 is a virtual image based on the second picture. In the present embodiment, the fourth image IM4 is displayed above the third image IM3.

A distance DA to the third image IM3 recognized by the viewer 14 can be controlled mainly by the curvature RA of the first concave surface 113aA of the first reflective member 113A. Likewise, a distance DB to the fourth image IM4 recognized by the viewer 14 can be controlled mainly by the curvature RB of the second concave surface 113aB of the second reflective member 113B. The larger the curvature RA or RB is, the closer the third image IM3 or the fourth image IM4 appears. Consequently, by making the curvatures RA and RB different from each other, the distance DA to the third image IM3 recognized by the viewer 14 and the distance DB to the fourth image IM4 recognized by the viewer 14 can be made different from each other. As a result, the viewer 14 can stereoscopically recognize the virtual images.

In the present embodiment, for example, the distance DA is made shorter than the distance DB by making the curvature RA larger than the curvature RB, so that the viewer 14 is made to recognize the third image IM3 closer than the fourth image IM4. For example, the third image IM3 is recognized at a position 5m ahead of the viewer 14, and the fourth image IM4 is recognized at a position 10m ahead of the viewer 14. In an example, as illustrated in FIG. 4, information representing a driving state of the automobile 1000, for example, a speed may be displayed in the third image IM3, and navigation information, for example, a corner direction may be displayed in the fourth image IM4.

The values of the curvature RA and the curvature RB depend on the design conditions of the image display device 10, and are roughly in a range from 5 mm to 1000 mm. In addition, a positive correlation is established between (i) and (ii), (i) being the curvatures RA, RB, and (ii) being the first optical path length LPA from the first display device 110A to the first reflective member 113A, and the second optical path length LPB from the second display device 110B to the second reflective member 113B. Thus, the optical path lengths need to be increased as the curvatures are increased. That is, RA>RB and LPA>LPB, or RA<RB and LPA<LPB. Note that RA=RB and LPA=LPB may be satisfied, but in this case, because DA=DB, no stereoscopic effect is obtained.

In an example, when the distance DA and the distance DB are set in a range from 3 m to 10 m, the size of the eye box 14a is set to 150 mm in the horizontal direction (X direction) and is set to 60 mm in the vertical direction (Z direction), the field of view (FOV) is set to 1.46° in the horizontal direction (X direction) and is set to 0.365° in the vertical direction (Z direction), and the size of the display device 110 is set to 2.2 mm×8.8 mm, the curvature RA and the curvature RB are in a range from 100 mm to 200 mm, and the first optical path length LPA and the second optical path length LPB are in a range from 80 mm to 90 mm.

Subsequently, an effect of the present embodiment is described. In the present embodiment, the light source unit 11 includes two display devices (the first display device 110A and the second display device 110B), and the curvature RA of the first concave surface 113aA of the first reflective member 113A and the curvature RB of the second concave surface 113aB of the second reflective member 113B are independently set, so that the distance DA to the third image IM3 and the distance DB to the fourth image IM4 can be independently set. Thus, a three-dimensional virtual image can be formed.

In the present embodiment, light emitted from the first display device 110A is emitted from the light source unit 11 via the first polarizing plate 111A, the reflective polarizing plate 117, the first wave plate 114A, the first reflective member 113A, the first wave plate 114A, the reflective polarizing plate 117, and the third wave plate 115. On the other hand, light emitted from the second display device 110B is emitted from the light source unit 11 via the second polarizing plate 111B, the reflective polarizing plate 117, the second wave plate 114B, the second reflective member 113B, the second wave plate 114B, the reflective polarizing plate 117, and the third wave plate 115. In this way, the light emitted from the first display device 110A to form the third image IM3 and the light emitted from the second display device 110B to form the fourth image IM4 pass through the same number and type of optical elements. Therefore, the quality of the third image IM3 and the quality of the fourth image IM4 can be uniformed, and a sense of mismatch between the third image IM3 and the fourth image IM4 is small when viewed by the viewer 14. As a result, a virtual image with good quality as a whole can be displayed.

In addition, because the light source unit 11 according to the present embodiment includes the third wave plate 115, the light LA and the light LB emitted from the light source unit 11 can be circularly polarized light. Thus, the difference in reflectance when the light LA and the light LB are reflected by the front windshield 13a is reduced, and the brightness of the third image IM3 and the brightness of the fourth image IM4 become uniform. This also improves the quality of a virtual image.

In addition, in the present embodiment, the first reflective member 113A and/or the second reflective member 113B have a substantially telecentric property on the first image IM1 side and/or the second image IM2 side, so that a high-quality image with a small size can be displayed. This effect is described in detail below.

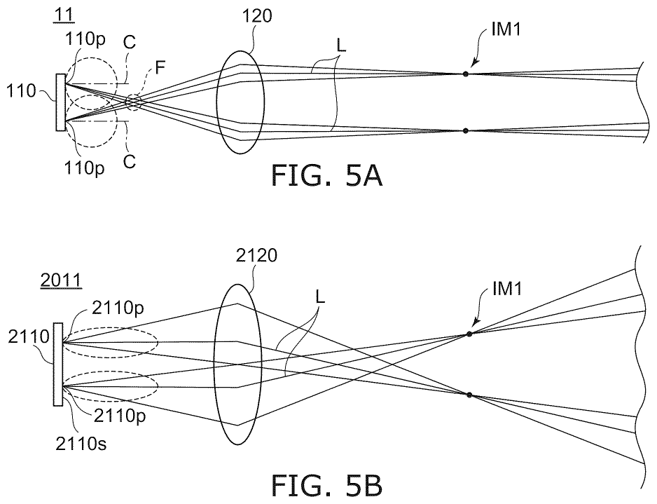

FIG. 5A is a schematic view illustrating the principle of the light source unit according to the present embodiment.

FIG. 5B is a schematic view illustrating the principle of a light source unit according to a reference example.

In FIG. 5A, light distribution patterns of light emitted from two pixels 110p among the plurality of pixels 110p of the display device 110 in the present embodiment are indicated by broken lines. Similarly, in FIG. 5B, light distribution patterns of light emitted from two pixels 2110p among a plurality of pixels 2110p of a display device 2110 in the reference example are indicated by broken lines. In addition, the imaging optical systems 120 and 2120 are illustrated in a simplified manner in FIGS. 5A and 5B.

As illustrated in FIG. 5B, in a light source unit 2011 according to the reference example, the display device 2110 is a liquid crystal display device (LCD) including the plurality of pixels 2110p. As indicated by the broken lines in FIG. 5B, light emitted from each pixel 2110p is mainly distributed in a normal direction of a light exit surface 2110s. Although there are many planes including the optical axis of the light emitted from one pixel 2110p, in the display device 2110 being the LCD, the light distribution patterns of the light emitted from one pixel 2110p in the planes are different from each other. In one plane of the plurality of planes, the light emitted from each pixel 2110p has a light distribution pattern in which the luminous intensity in a direction at an angle e with respect to the optical axis is approximated by cos200 times the luminous intensity on the optical axis.

In such a display device 2110, even light emitted from the same position of the display device 2110 changes luminous intensity and chromaticity depending on the viewing angle of a viewer. Consequently, when the first reflective member 113A and/or the second reflective member 113B (hereinafter, collectively referred to as “reflective member”) receive light emitted from each pixel 2110p in a direction other than the normal direction, even though the luminance of the light emitted from all the pixels 2110p is made uniform, variations in luminance and chromaticity occur in the first image IM1 and/or the second image (hereinafter, collectively referred to as “first image or the like”). That is, the quality of the first image or the like is degraded. Consequently, to prevent the quality of the first image or the like from being degraded, the light emitted from each pixel 2110p of the display device 2110 needs to be received along the normal direction. As a result, the reflective member is increased in size.

On the other hand, in the light source unit 11 according to the present embodiment, the reflective member has a substantially telecentric property on the side of the first image or the like, and light emitted from the display device 110 has a substantially Lambertian light distribution. Therefore, the quality of the first image or the like can be improved while reducing the size of the light source unit 11. Specifically, the display device 110 is an LED display including the plurality of LED elements 112, and light emitted from each LED element 112 has a substantially Lambertian light distribution. Therefore, the dependence of the luminous intensity and chromaticity of light emitted from each pixel 110p of the display device 110 on an angle is lower than the dependence of the luminous intensity and chromaticity of light emitted from each pixel 2110p of the display device 2110 on an angle in the reference example. In particular, as the light distribution becomes closer to a strict Lambertian light distribution, that is, as n of cosne being an approximate expression of the light distribution pattern becomes closer to 1, the luminous intensities and chromaticities of the light emitted from the pixels 110p of the display device 110 become substantially uniform regardless of an angle. Therefore, as illustrated in FIG. 5A, even though the reflective member receives light along a direction other than the normal direction, variations in the luminous intensity and chromaticity of the first image or the like can be suppressed and the quality of the first image or the like can be improved.

In the present embodiment, the first image or the like is formed between the light source unit 11 and the reflection unit 12. In such a case, light emitted from any one point of the display device 110 is condensed at the formation position of the first image or the like. On the other hand, when the first image or the like is not formed between the light source unit 11 and the reflection unit 12, the light diameter of light emitted from any one point of the display device 110 gradually increases from the light source unit 11 toward the reflection unit 12. Consequently, in the present embodiment, the range of the third wave plate 115 irradiated with the light emitted from a certain point of the display device 110 can be made smaller than when the first image or the like is not formed. Therefore, the third wave plate 115 can be reduced in size.

In addition, because the light source unit 11 according to the present embodiment is small, when the light source unit 11 is mounted on the vehicle 13 and used as a head-up display, the light source unit 11 can be easily disposed in a limited space in the vehicle 13.

### Examples

Light source units according to examples and a reference example are described below.

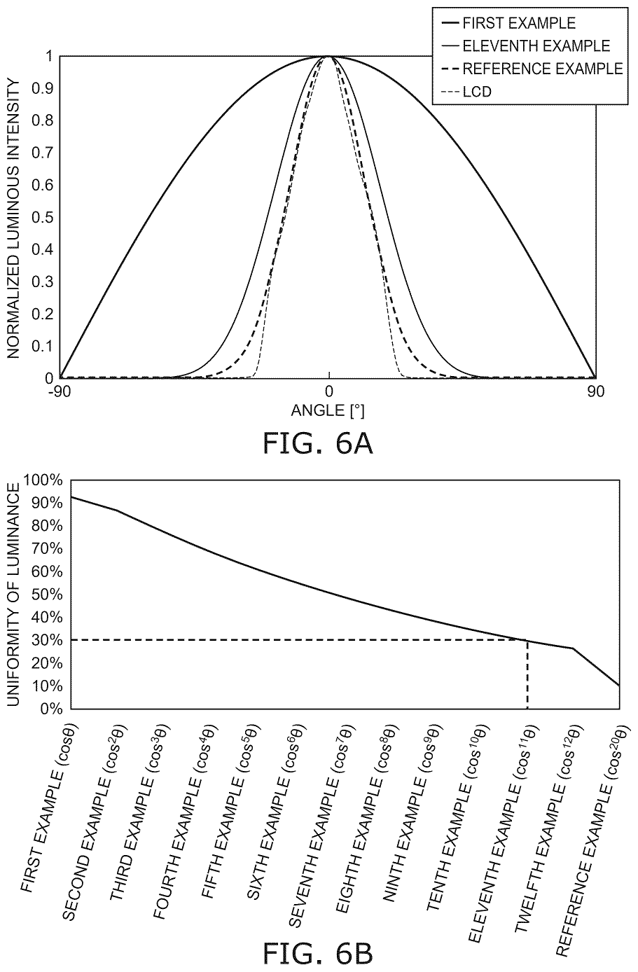

FIG. 6A is a graph showing light distribution patterns of light emitted from one light-emitting area in first and eleventh examples, the reference example, and LCD.

FIG. 6B is a graph showing the uniformity of luminance of a third image in the first to twelfth examples and the reference example.

Setting was performed on the simulation software such that image display devices according to the first to twelfth examples and the reference example each include a light source unit and a reflection unit and the light source unit includes a plurality of light-emitting areas arranged in a matrix and an imaging optical system including the first polarizing plate 111A, the reflective polarizing plate 117, the first reflective member 113A, the first wave plate 114A, and the third wave plate 115. Each light-emitting area corresponds to each pixel 110p of the display device 110 in the above embodiment.

In FIG. 6A, a horizontal axis represents the angle of the light-emitting area with respect to an optical axis, and a vertical axis represents the normalized luminous intensity obtained by dividing the luminous intensity at the angle by the luminous intensity on the optical axis and denotes a relative value when the maximum value is 1. As illustrated in FIG. 6A, a display device according to the first example was set on the simulation software such that light emitted from each light-emitting area has a light distribution pattern in which the luminous intensity in a direction at an angle θ with respect to the optical axis is represented by cosθ times the luminous intensity on the optical axis. That is, in the first example, the light emitted from each light-emitting area has a strict Lambertian light distribution.

In the second to twelfth examples, the light emitted from each light-emitting area was set on the simulation software so as to have a light distribution pattern in which the luminous intensity in the direction at the angle e with respect to the optical axis is represented by cosne times the luminous intensity on the optical axis. In the second example, n=2, and n was Set so as to increase by 1 in the order from the second to twelfth examples.

When a light distribution pattern of light emitted from a pixel of the LCD in one plane was investigated, the light distribution pattern was found to be a light distribution pattern as indicated by a thin broken line in FIG. 6A. As described above, it was found that this light distribution pattern can be approximated to a light distribution pattern in which the luminous intensity in the direction at the angle e with respect to the optical axis is represented by cos200 times the luminous intensity on the optical axis. Therefore, in the reference example, setting was performed on the simulation software such that a light distribution pattern is provided in which the luminous intensity of each light-emitting area in the direction at the angle θ with respect to the optical axis is represented by cos²⁰θ times the luminous intensity on the optical axis.

The imaging optical systems in the first to twelfth examples and the reference example, that is, optical functions including the first polarizing plate 111A, the reflective polarizing plate 117, the first reflective member 113A, the first wave plate 114A, and the third wave plate 115 were all set so as to have a telecentric property on the first image side.

Subsequently, for each of the first to twelfth examples and the reference example, the luminance distribution of the third image formed when the luminance of all the light-emitting areas was set uniform was simulated. At this time, the third image was a rectangle with a long side of 111.2 mm and a short side of 27.8 mm. In this case, the plane on which the third image is formed was divided into square areas each with a side of 1 mm, and the luminance value of each of the areas was simulated.

In addition, the uniformity of luminance in the third image was evaluated. The “uniformity of luminance” refers to a value representing the proportion of the minimum value to the maximum value of luminance in the third image in percentage. The results are shown in FIG. 6B. In FIG. 6B, a horizontal axis represents each example and the reference example, and a vertical axis represents the uniformity of luminance.

As shown in FIG. 6B, it was found that as n increases, the uniformity of luminance decreases. This is because the luminance at a position away from the center in the third image decreases as n increases. In particular, in the eleventh example, that is, when n=11, the uniformity of luminance was found to be 30%. In order for a viewer to easily distinguish the third image from an area where the third image is not formed, it is conceivable that the uniformity of the luminance in the third image may be 30% or more.

Consequently, it was found that when the imaging optical system is configured to have a substantially telecentric property, light emitted from the display device preferably has a substantially Lambertian light distribution in order to suppress luminance unevenness in the first image and the third image. Specifically, it was found that in cosme being an approximate expression of the light distribution pattern, n is preferably 11 or less, more preferably 1. Although the uniformity of luminance in the third image IM3 decreases as n deviates from 1 as described above, a predetermined luminance distribution can be provided in advance in the display luminance of the display device 110 so that such unevenness of the luminance can be compensated for. For example, when the luminance of an outer edge portion of the second image IM2 is likely to be lower than the luminance of a central portion thereof due to passage of light emitted from each pixel 110p of the display device 110 through the imaging optical system, the display device 110 may be controlled such that the output of the LED elements 112 of the pixel 110p on the outer edge side of the display device 110 is higher than the output of the LED elements 112 of the pixel 110p on the central side.

### Second Embodiment

A second embodiment is described below.

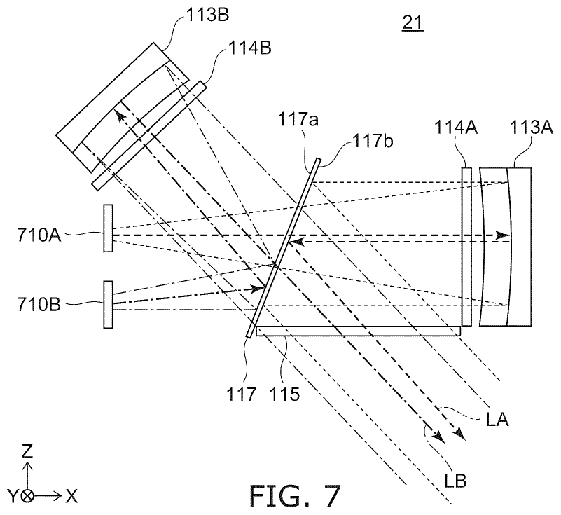

FIG. 7 is an end view illustrating a light source unit according to the present embodiment.

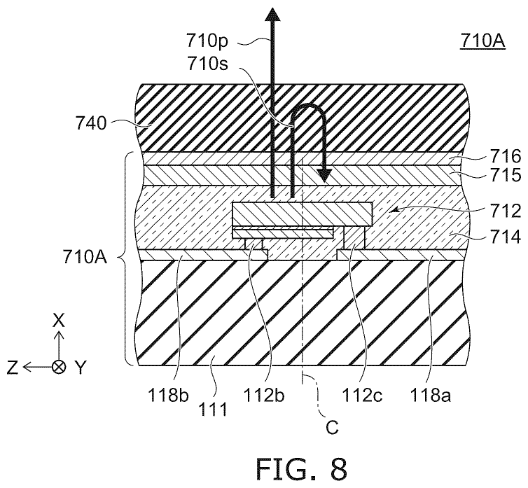

FIG. 8 is a cross-sectional view illustrating an enlarged portion of a first display device in the present embodiment.

As illustrated in FIG. 7, a light source unit 21 according to the present embodiment is different from the light source unit 11 according to the first embodiment in that a first display device 710A is provided instead of the first display device 110A and the first polarizing plate 111A and a second display device 710B is provided instead of the second display device 110B and the second polarizing plate 111B.

As illustrated in FIG. 8, the first display device 710A in the present embodiment is different from the first display device 110A in the first embodiment in that light exit surfaces of LED elements 712 are substantially flat and a protective layer 714, a wavelength conversion member 715, a light scattering member 716, and a first polarizing plate 740 are further provided. The first polarizing plate 740 is disposed above the LED element 712, and light emitted from the LED element 112 is incident on the first polarizing plate 740. The other configurations of the display device 710A are the same as or similar to those of the first display device 110A in the first embodiment.

Likewise, in the second display device 710B, the light exit surfaces of the LED elements 712 are substantially flat, and the protective layer 714, the wavelength conversion member 715, the light scattering member 716, and a second polarizing plate are further provided. The other configurations of the second display device 710B are the same as or similar to those of the second display device 110B in the first embodiment. In the following description, the first display device 710A is described, but the same applies to the second display device 710B.

In the first display device 710A, the protective layer 714 covers the plurality of LED elements 712 arranged in a matrix. The protective layer 714 can include, for example, a light-transmitting material such as a polymer material that includes a sulfur (S)—including substituent group or a phosphorus (P) atom—including group, a high refractive index nanocomposite material in which inorganic nanoparticles having a high refractive index are added to a polymer matrix of polyimide, or the like.

The wavelength conversion member 715 is disposed on the protective layer 714. The wavelength conversion member 715 includes one or more kinds of wavelength conversion materials such as a general phosphor material, a perovskite phosphor material, or a quantum dot (QD). Light emitted from each LED element 712 is incident on the wavelength conversion member 715. In response to entry of the light emitted from each LED element 712, the wavelength conversion material included in the wavelength conversion member 715 emits light with a light emission peak wavelength different from the light emission peak wavelength of each LED element 712. The light emitted by the wavelength conversion member 715 has a substantially Lambertian light distribution.

The light scattering member 716 includes, for example, a resin member having a light-transmitting property and light scattering particles or voids in the resin member. Examples of the resin member include polycarbonate. Examples of the light scattering particles include a material having a refractive index different from that of the resin member, such as titanium oxide. The light scattering effect may be obtained by roughening the surface of the light scattering member 716 to provide irregularities.

Examples of the first polarizing plate 740 that can be used include a multilayer thin film layered polarizing plate in which thin film layers with different polarization characteristics are layered. The first polarizing plate 740 is disposed on the light scattering member 716. Therefore, light emitted from the LED element 712 and the wavelength conversion member 715 is incident on the first polarizing plate 740. The first polarizing plate 740 transmits first polarized light 710p of the light emitted from the wavelength conversion member 715, and reflects second polarized light 710s toward the wavelength conversion member 715. The oscillation direction of an electric field of the second polarized light 710s is substantially orthogonal to the oscillation direction of an electric field of the first polarized light 710p. In the present embodiment, the first polarized light 710p is P-polarized light, and the second polarized light 710s is S-polarized light.

Specifically, as illustrated in FIG. 8, the 2avelength conversion member 715 is irradiated with the light emitted from the LED element 712. Thus, the wavelength conversion member 715 is excited to emit light with a light emission peak wavelength longer than the light emission peak wavelength of the light emitted from the LED element 712. In the present embodiment, the light emitted from the wavelength conversion member 715 includes light emitted from the LED element 712 and not wavelength-converted by the wavelength conversion member 715 and light emitted from the LED element 712 and wavelength-converted by the wavelength conversion member 715. Hereinafter, of the light emitted from the wavelength conversion member 715, the light emitted from the LED element 712 and not wavelength-converted by the wavelength conversion member 715 is also referred to as “short-wavelength light”, and the light emitted from the LED element 712 and wavelength-converted by the wavelength conversion member 715 is also referred to as “long-wavelength light”. However, most of the light emitted from the LED element 712 may be absorbed by the wavelength conversion member 715.

Most of the first polarized light 710p included in the short-wavelength light and the long-wavelength light passes through the first polarizing plate 740 and is emitted from the first display device 710A. Most of the second polarized light 710s included in the short-wavelength light and the long-wavelength light is reflected by the first polarizing plate 740. A part of the second polarized light 710s reflected by the first polarizing plate 740 is scattered and reflected by the components of the first display device 710A such as the light scattering member 716 and the wavelength conversion member 715. Due to the scattering reflection, a part of the second polarized light 710s is converted into the first polarized light 710p. A part of the first polarized light 710s converted from the second polarized light 710p passes through the first polarizing plate 740 and is emitted from the first display device 710A. Therefore, the luminance of the first image IM1 can be improved while increasing the proportion of the first polarized light 710p included in the light emitted from the first display device 710A. Because the luminance of the first image IM1 is improved, the luminance of the third image IM3 is also improved. Thus, the viewer 14 can easily view the third image IM3.

In addition, a part of the short-wavelength light included in the second polarized light 710s may be incident on the wavelength conversion member 715 after being reflected by the first polarizing plate 740. In this case, the wavelength conversion member 715 can be expected to absorb the short-wavelength light of the second polarized light 710s and additionally emit long-wavelength light. Each of the scattered reflected light and the radiated light has a substantially Lambertian light distribution. In addition, the first polarizing plate 740 itself may scatter and reflect the second polarized light 710s. Also in such a case, a part of the second polarized light 710s is converted into the first polarized light 710p by scattering reflection.

Likewise, in the second display device 710B, the luminance of the second image IM2 can be improved while increasing the proportion of the second polarized light 710s included in the light emitted from the second display device 710B. Because the luminance of the second image IM2 is improved, the luminance of the fourth image IM4 is also improved. Thus, the viewer 14 can easily view the fourth image IM4.

In the present embodiment, one first polarizing plate 740 covers all pixels of the first display device 710A. However, the first display device 710A may include a plurality of first polarizing plates 740, and each of the first polarizing plates 740 may be disposed on each pixel. The configuration of the first display device is not limited to the above. For example, the first display device may be configured with no light scattering member by using the light scattering reflection effect of the wavelength conversion member. In addition, the first display device may be configured with no wavelength conversion member by using the scattering reflection effect of the light scattering member. In addition, as in the first embodiment, the first display device may be configured with neither the wavelength conversion member nor the light scattering member by using the light scattering reflection effect of a plurality of recessed portions or a plurality of protruding portions provided on the light exit surface of the LED element. The same applies to the second display device.

An effect of the present embodiment is described below.

In the present embodiment, by incorporating the first polarizing plate 740 into the first display device 710A and incorporating the second polarizing plate into the second display device 710B, the light source unit 21 can be further reduced in size.

Light emitted from the first polarizing plate 740 also has a substantially Lambertian light distribution. Therefore, the present embodiment can also provide the light source unit 21 that is small and can form the first image and the like with high quality. Because the plurality of LED elements 712 are discretely mounted on the substrate 111, a grainy appearance may occur in the first image or the like. The wavelength conversion member 715 has an effect of reducing the grainy appearance. The light scattering member 716 can further reinforce the effect of reducing the grainy appearance. The configuration, operation, and effects of the present embodiment other than those described above are the same as or similar to those of the first embodiment.

### Third Embodiment

A third embodiment is described below.

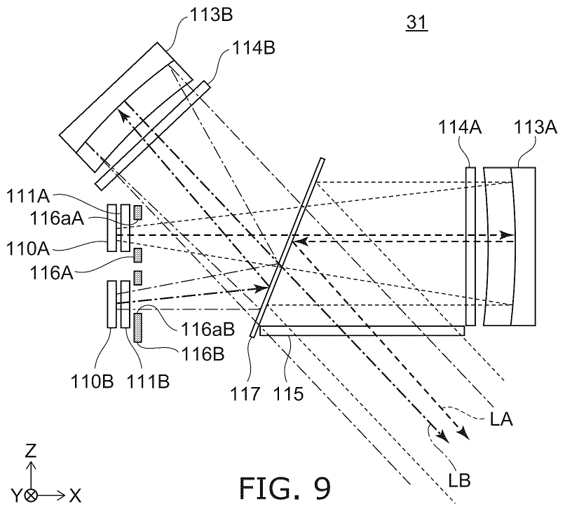

FIG. 9 is an end view illustrating a light source unit according to the present embodiment.

As illustrated in FIG. 9, a light source unit 31 according to the present embodiment is different from the light source unit 11 according to the first embodiment in that a first light-shielding member 116A and a second light-shielding member 116B are provided.

The first light-shielding member 116A is disposed on an optical path from the first display device 110A to the first reflective member 113A. The first light-shielding member 116A is provided with an aperture 116aA through which a part of light traveling from the first display device 110A toward the first reflective member 113A passes. The first light-shielding member 116A blocks another part of the light traveling from the first display device 110A toward the first reflective member 113A. For example, the first light-shielding member 116A is disposed between the first polarizing plate 111A and the reflective polarizing plate 117.

The second light-shielding member 116B is disposed on an optical path from the second display device 110B to the second reflective member 113B. The second light-shielding member 116B is provided with an aperture 116aB through which a part of light traveling from the second display device 110B toward the second reflective member 113B passes. The second light-shielding member 116B blocks another part of the light traveling from the second display device 110B toward the second reflective member 113B. For example, the second light-shielding member 116B is disposed between the second polarizing plate 111B and the reflective polarizing plate 117.

According to the present embodiment, the first light-shielding member 116A and the second light-shielding member 116B are provided, so that the generation of stray light can be suppressed and the quality of a virtual image can be further improved. The configuration, operation, and effects of the present embodiment other than those described above are the same as or similar to those of the first embodiment.

### Fourth Embodiment

A fourth embodiment is described below.

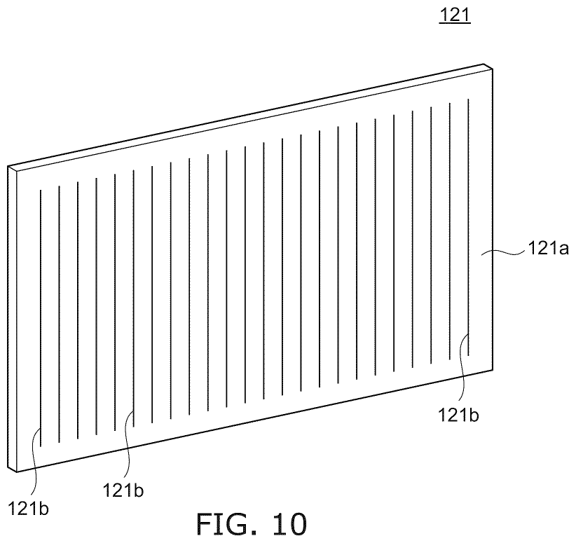

FIG. 10 is a perspective view illustrating a wire grid polarizing plate in the present embodiment.

In the present embodiment, wire grid polarizing plates 121 are provided as a first polarizing plate and a second polarizing plate, respectively.

As illustrated in FIG. 10, in the wire grid polarizing plate 121, a plurality of metal wires 121b are arranged in parallel with each other at equal intervals on a transparent resin film 121a. Thus, the wire grid polarizing plate 121 transmits the first polarized light of the light emitted from the LED element and reflects the second polarized light thereof to return to the LED element. Alternatively, the wire grid polarizing plate 121 transmits the second polarized light of the light emitted from the LED element and reflects the first polarized light thereof such that it returns to the LED element. The configuration, operation, and effects of the present embodiment other than those described above are the same as or similar to those of the first embodiment.

Each of the aforementioned embodiments is an example embodying the present invention, and the present invention is not limited to these embodiments. For example, additions, deletions, or changes of some components or steps in each of the aforementioned embodiments are also included in the present invention. The aforementioned embodiments can be implemented in combination with each other.

The embodiments include the following clauses.

### Clause 1

A light source unit comprising:
a first display device capable of displaying a first picture;
a second display device capable of displaying a second picture;
a first polarizing plate configured to convert light emitted from the first display device into first polarized light having a first polarization direction;

a second polarizing plate configured to convert light emitted from the second display device into second polarized light having a second polarization direction different from the first polarization direction;
a reflective polarizing plate configured to transmit the first polarized light and reflect the second polarized light;
a first reflective member that comprises a first concave surface, and is configured to reflect, from the first concave surface, the first polarized light transmitted through the reflective polarizing plate toward the reflective polarizing plate and project a first image corresponding to the first picture on a projection part, thereby allowing an image visually recognizable by a viewer to be displayed beyond the projection part when viewed by the viewer;
a first wave plate disposed between the reflective polarizing plate and the first reflective member;
a second reflective member that comprises a second concave surface, and is configured to reflect, from the second concave surface, the second polarized light reflected by the reflective polarizing plate toward the reflective polarizing plate and project a second image corresponding to the second picture on the projection part, thereby allowing an image visually recognizable by the viewer to be displayed beyond the projection part when viewed by the viewer; and
a second wave plate disposed between the reflective polarizing plate and the second reflective member, wherein
a first optical path length of the light emitted from the first display device from the first display device to the first reflective member is longer than a second optical path length of the light emitted from the second display device from the second display device to the second reflective member and a curvature of the first concave surface is larger than a curvature of the second concave surface, or
the first optical path length is shorter than the second optical path length and the curvature of the first concave surface is smaller than the curvature of the second concave surface.

### Clause 2

The light source unit according to clause 1, further comprising: a third wave plate configured to transmit the light reflected by the first reflective member and reflected by the reflective polarizing plate and the light reflected by the second reflective member and transmitted through the reflective polarizing plate.

### Clause 3

The light source unit according to clause 2, wherein the first wave plate, the second wave plate, and the third wave plate are ¼ λ plates.

### Clause 4

The light source unit according to any one of clauses 1 to 3, wherein
at least one of the first reflective member and/or the second reflective member has a substantially telecentric property on a side of the first image and/or a side of the second image, and
at least one of the light emitted from the first display device and/or the light emitted from the second display device has a substantially Lambertian light distribution.

### Clause 5

The light source unit according to clause 4, wherein
the light emitted from the first display device has a light distribution pattern in which a luminous intensity of the light emitted from the first display device in a direction at an angle θ with respect to an optical axis of the light emitted from the first display device is approximated by cosme times a luminous intensity on the optical axis,
the light emitted from the second display device has a light distribution pattern in which a luminous intensity of the light emitted from the second display device in a direction at the angle θ with respect to the optical axis of the light emitted from the second display device is approximated by cosⁿ²θ times a luminous intensity on the optical axis, and
each of n1 and n2 is a value greater than 0.

### Clause 6

The light source unit according to clause 5, wherein each of n1 and n2 is 11 or less.

### Clause 7

The light source unit according to any one of clauses 1 to 6, wherein
the first display device is a first LED display comprising a plurality of LED elements, and
the second display device is a second LED display comprising a plurality of LED elements.

### Clause 8

The light source unit according to clause 7, wherein light emitted from an LED element of the LED elements has a substantially Lambertian light distribution.

### Clause 9

The light source unit according to clause 7 or 8, wherein
the first display device further comprises a first wavelength conversion member that is disposed above an LED element of the LED elements of the first display device and is configured to receive light emitted from the LED element, and
the second display device further comprises a second wavelength conversion member that is disposed above an LED element of the LED elements of the second display device and is configured to receive light emitted from the LED element.

### Clause 10

The light source unit according to any one of clauses 1 to 9, further comprising:
a first light-shielding member that is disposed on an optical path from the first display device to the first reflective member, is provided with an aperture through which a part of light traveling from the first display device toward the first reflective member passes, and is configured to block another part of the light traveling from the first display device toward the first reflective member; and
a second light-shielding member that is disposed on an optical path from the second display device to the second reflective member, is provided with an aperture through which a part of light traveling from the second display device toward the second reflective member passes, and is configured to block another part of the light traveling from the second display device toward the second reflective member.

### Clause 11

A image display device comprising:
the light source unit according to any one of clauses 1 to 10; and
a reflection unit that is spaced apart from the light source unit and is configured to reflect light emitted from the light source unit, wherein
the first image and the second image are formed between the light source unit and the reflection unit.

### Clause 12

An automobile comprising:
a vehicle; and
the image display device according to clause 11, the image display device being fixed to the vehicle.

### Industrial Applicability

The present invention can be used, for example, in a head-up display.

### Reference Signs List

10 Image display device
11 Light source unit
12 Reflection unit
13 Vehicle
13a Front windshield
13b Ceiling portion
13c Dashboard portion
13h1, 13h2 Through hole
13s1, 13s2 Wall
14 Viewer
14a Eye box
21 Light source unit
31 Light source unit
110 Display device
110A First display device
110B Second display device
110p Pixel
111 Substrate
111A First polarizing plate
111B Second polarizing plate
112 LED element
112a Semiconductor layered body
112b Anode electrode
112c Cathode electrode
112p1 p-type semiconductor layer
112p2 Active layer
112p3 n-type semiconductor layer
112s Light exit surface
112t Recessed portion
113A First reflective member
113aA First concave surface
113B Second reflective member
113aB Second concave surface
114A First wave plate
114B Second wave plate
115 Third wave plate
116A First light-shielding member
116aA Aperture
116B Second light-shielding member
116aB Aperture
117 Reflective polarizing plate
117a First surface
117b Second surface
118a, 118b Wiring part
120, 2120 Imaging optical system
121 Wire grid polarizing plate
121a Resin film
121b Metal wire
131 Mirror
131a Mirror surface
710A First display device
710B Second display device
712 LED element
714 Protective layer
715 Wavelength conversion member
716 Light scattering member
740 First polarizing plate
1000 Automobile
2011 Light source unit
2110 Display device
2110p Pixel
2110s Light exit surface
C Optical axis
DA, DB Distance
IM1 First image
IM2 Second image
IM3 Third image
IM4 Fourth image
LA Light
LB Light
LPA First optical path length
LPB Second optical path length
RA Curvature
RB Curvature
a1 Point
a2 Point
θ: Angle

1. A light source unit comprising:
a first display device configured to display a first picture;
a second display device configured to display a second picture;
a first polarizing plate configured to convert light emitted from the first display device into first polarized light having a first polarization direction;
a second polarizing plate configured to convert light emitted from the second display device into second polarized light having a second polarization direction different from the first polarization direction;
a reflective polarizing plate configured to transmit the first polarized light and reflect the second polarized light;
a first reflective member that comprises a first concave surface, and is configured to reflect, from the first concave surface, the first polarized light transmitted through the reflective polarizing plate toward the reflective polarizing plate and project a first image corresponding to the first picture on a projection part, thereby allowing an image visually recognizable by a viewer to be displayed beyond the projection part when viewed by the viewer;
a first wave plate disposed between the reflective polarizing plate and the first reflective member;
a second reflective member that comprises a second concave surface, and is configured to reflect, from the second concave surface, the second polarized light reflected by the reflective polarizing plate toward the reflective polarizing plate and project a second image corresponding to the second picture on the projection part, thereby allowing an image visually recognizable by the viewer to be displayed beyond the projection part when viewed by the viewer; and
a second wave plate disposed between the reflective polarizing plate and the second reflective member, wherein:
(i) a first optical path length of the light emitted from the first display device from the first display device to the first reflective member is longer than a second optical path length of the light emitted from the second display device from the second display device to the second reflective member, and a curvature of the first concave surface is larger than a curvature of the second concave surface, or (ii) the first optical path length is shorter than the second optical path length and the curvature of the first concave surface is smaller than the curvature of the second concave surface.

2. The light source unit according to claim 1, further comprising:
a third wave plate configured to transmit the light reflected by the first reflective member and reflected by the reflective polarizing plate and the light reflected by the second reflective member and transmitted through the reflective polarizing plate.

3. The light source unit according to claim 2, wherein the first wave plate, the second wave plate, and the third wave plate are ¼ λ plates.

4. The light source unit according claim 1, wherein:
the first reflective member and/or the second reflective member has a substantially telecentric property on a side of the first image and/or a side of the second image, and
the light emitted from the first display device and/or the light emitted from the second display device has a substantially Lambertian light distribution.

5. The light source unit according to claim 4, wherein
the light emitted from the first display device has a light distribution pattern in which a luminous intensity of the light emitted from the first display device in a direction at an angle θ with respect to an optical axis of the light emitted from the first display device is approximated by cosⁿ¹θ times a luminous intensity on the optical axis, and
n1 is a value greater than 0.

6. The light source unit according to claim 5, wherein n1 is 11 or less.

7. The light source unit according to claim 1, wherein:
the first display device is a first LED display comprising a plurality of LED elements, and
the second display device is a second LED display comprising a plurality of LED elements.

8. The light source unit according to claim 7, wherein light emitted from an LED element of the LED elements has a substantially Lambertian light distribution.

9. The light source unit according to claim 7, wherein;
the first display device further comprises a first wavelength conversion member that is disposed above an LED element of the LED elements of the first display device and is configured to receive light emitted from the LED element, and
the second display device further comprises a second wavelength conversion member that is disposed above an LED element of the LED elements of the second display device and is configured to receive light emitted from the LED element.

10. The light source unit according to claim 1, further comprising:
a first light-shielding member that is disposed on an optical path from the first display device to the first reflective member, comprises an aperture through which a part of light traveling from the first display device toward the first reflective member passes, and is configured to block another part of the light traveling from the first display device toward the first reflective member; and
a second light-shielding member that is disposed on an optical path from the second display device to the second reflective member, comprises an aperture through which a part of light traveling from the second display device toward the second reflective member passes, and is configured to block another part of the light traveling from the second display device toward the second reflective member.

11. A image display device comprising:
the light source unit according to claim 1; and
a reflection unit that is spaced apart from the light source unit and is configured to reflect light emitted from the light source unit, wherein:
the first reflective member is configured to project the first image to a location between the light source unit and the reflection unit, and
the second reflective member is configured to project the second image to a location between the light source unit and the reflection unit.

12. An automobile comprising:
a vehicle; and
the image display device according to claim 11, the image display device being fixed to the vehicle.

13. The light source unit according to claim 5, wherein:
the light emitted from the second display device has a light distribution pattern in which a luminous intensity of the light emitted from the second display device in a direction at the angle 0 with respect to the optical axis of the light emitted from the second display device is approximated by cosⁿ²θ times a luminous intensity on the optical axis, and
n2 is a value greater than 0.

14. The light source unit according to claim 13, wherein n2 is 11 or less.
